(19) United States
(12) Patent Application Publication
(10) Pub. No.: US 2020/0218081 A1
(43) Pub. Date: Jul. 9, 2020

(54) SPECKLE ELIMINATION APPARATUS, LASER SOURCE, AND LASER PROJECTION SYSTEM

(71) Applicant: GOERTEK INC., Weifang, Shandong (CN)

(72) Inventor: Lebao YANG, Weifang, Shandong (CN)

(73) Assignee: GOERTEK INC., Weifang, Shandong (CN)

(21) Appl. No.: 16/648,133

(22) PCT Filed: Dec. 8, 2017
(86) PCT No.: PCT/CN2017/115236

§ 371 Date: Mar. 17, 2020

(30) Foreign Application Priority Data
Sep. 29, 2017 (CN) 201721269570.6

(51) Int. Cl. G02B 27/48; G03B 21/20; G02B 27/28

(52) U.S. Cl. CPC G02B 27/48; G02B 27/28; G03B 21/2033

(57) ABSTRACT

The utility model discloses a speckle elimination apparatus, a laser source, and a laser projection system. The speckle elimination apparatus includes a wave plate on a laser optical path, the wave plate being arranged to allow 25%-75% of an incident laser beam to pass through directly. The utility model can eliminate the laser speckle phenomenon.

### FIELD OF THE INVENTION

The present utility model relates to the field of laser technologies, and in particular to a speckle elimination apparatus, a laser source, and a laser projection system.

### BACKGROUND OF THE INVENTION

When the laser source is used as a light source of a projection system, the laser beam itself may generate spot interference (self-coherence) due to the high coherence of the laser. The conditions for generating the self-coherence by the laser beam are: laser frequencies are the same, vibration directions are consistent, and phase difference is constant. The spot interference may result in a formation of stray light with nonuniform brightness at the side of a laser emergent spot, which is referred to as a laser speckle phenomenon. The laser speckle phenomenon may affect the imaging effect of the projection.

Therefore, a speckle elimination apparatus that can eliminate the laser speckle phenomenon by changing the vibration direction of a portion of the laser, a laser source, and a laser projection system need to be provided.

### SUMMARY OF THE INVENTION

The objective of the present utility model is to provide a speckle elimination apparatus, a laser source, and a laser projection system, to eliminate a laser speckle phenomenon by changing a polarization state of a portion of a laser beam.

In order to achieve the above objective, the present utility model adopts the following technical solutions.

The present utility model discloses a speckle elimination apparatus, comprising a wave plate on a laser optical path, the wave plate being arranged to allow 25%-75% of an incident laser beam to pass through directly.

Preferably, the wave plate is arranged to allow 50% of the incident laser beam to pass through directly.

Preferably, the wave plate is a half-wave plate.

Preferably, the speckle elimination apparatus further comprises a diaphragm on an emergent optical path of the wave plate.

Preferably, the wave plate is an annular wave plate having a central opening.

Preferably, the wave plate is an annular wave plate having a central opening of a centrosymmetric shape, the annular wave plate being arranged concentrically with a light through hole of the diaphragm.

Preferably, the wave plate is an annular wave plate having a central circular opening, the annular wave plate being arranged concentrically with a light through hole of the diaphragm.

Preferably, the wave plate is arranged adjacent to the diaphragm on an optical path direction.

The present utility model further discloses a laser source, comprising a laser device for emitting laser, and further comprising the speckle elimination apparatus described above.

The present utility model further discloses a laser projection system, comprising the laser source described above.

The present invention has the following beneficial effects:

According to the technical solutions of the present utility model, the laser speckle phenomenon can be eliminated by changing the polarization state of a portion of the laser beam, with a small size, a simple structure, and high reliability.

### BRIEF DESCRIPTION OF THE DRAWINGS

The specific embodiments of the present invention will be further described below with reference to the drawings.

FIG. 1 illustrates a sectional view of a speckle elimination apparatus.

FIG. 2 illustrates a sectional view of a speckle elimination apparatus using an alternative manner.

### DETAILED DESCRIPTION OF THE PREFERRED EMBODIMENTS

In order to describe the present utility model more clearly, the present utility model will be further described below in combination with the preferred embodiments and the drawings. Similar components in the drawings are denoted by the same reference numerals. Those skilled in the art should understand that the following detailed description is merely for illustration instead of limitation, and the protection scope of the present utility model shall not he limited thereto.

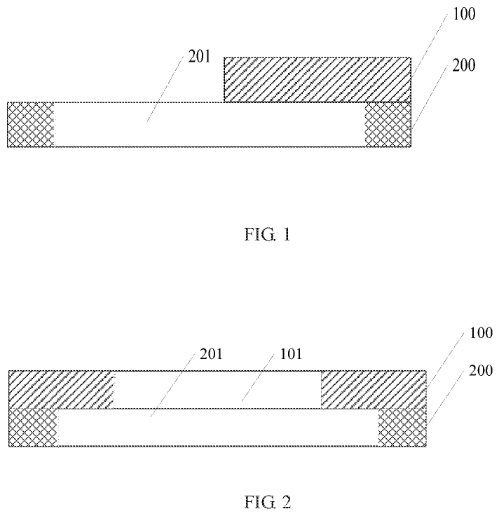

As shown in FIG. 1, a speckle elimination apparatus provided by this embodiment comprises a wave plate 100 sequentially arranged on a laser optical path, the wave plate 100 being arranged to allow 25%-75% of an incident laser beam to pass through directly. A polarization state of a portion of the incident laser beam that directly passes through the wave plate 100 is not changed, while a polarization state of the remainder of the incident laser beam is changed by the wave plate 100. Since vibration directions of the laser having a changed polarization state and the laser having an unchanged polarization state in the incident laser beam are different, interference will not be formed therebetween, thereby eliminating a laser speckle phenomenon of the incident laser beam.

In a specific implementation, the wave plate 100 is arranged to allow 50% of the incident laser beam to pass through directly, so that a polarization state of a half of the laser in the incident laser beam can be changed, that is, the laser having a changed polarization state or the laser having an unchanged polarization state in the incident laser beam occupies a half of the incident laser beam respectively, in which case an effect of eliminating the laser speckle phenomenon of the incident laser beam is better.

In a specific implementation, the wave plate 100 is a half-wave plate, so that the vibration directions of the laser having a polarization state changed by the wave plate 100 in the incident laser beam and the laser that directly passes through the wave plate 100 without changing its polarization state in the incident laser beam are perpendicular to each other, in which case the effect of eliminating the laser speckle phenomenon of the incident laser beam is better. For example, when the incident laser is S-linearly polarized light, 25%-75% of the incident laser beam directly passes through the half-wave plate, a polarization state of a portion of the incident laser beam that directly passes through the half-wave plate is not changed (that is, the portion of the incident laser beam that directly passes through the half-wave plate is still S-linearly polarized light), while the remainder of the incident laser beam is converted into P-linearly polarized light. Since vibration directions of the P-linearly polarized light and the S-linearly polarized light are perpendicular to each other, interference will not be formed therebetween, thereby eliminating the laser speckle phenomenon of the incident laser beam. Similarly, when the incident laser beam is P-linearly polarized light, a portion of the incident laser beam is converted into S-linearly polarized light, likewise eliminating the laser speckle phenomenon of the incident laser beam.

In a specific implementation, the speckle elimination apparatus further comprises a diaphragm 200 on an emergent optical path of the wave plate 100. Further, the wave plate 100 is arranged adjacent to the diaphragm 200 in an optical path direction, so that an effect of limiting the incident laser beam by the diaphragm 200 is better, and miniaturization of the speckle elimination apparatus becomes possible, thereby saving the space and reducing an overall size of the apparatus.

As a preferred alternative manner, the wave plate 100 is an annular wave plate having a central opening. Further, the wave plate 100 is an annular wave plate having a central opening of a centrosymmetric shape, the annular wave plate being arranged concentrically with a light through hole 201 of the diaphragm 200. Most preferably, as shown in FIG. 2, the wave plate 100 is an annular wave plate having a central circular opening, the annular wave plate being arranged concentrically with the light through hole 201 of the diaphragm 200. In this case, a positional relationship between the wave plate 100 and the diaphragm 200 on the optical path can be easily adjusted.

In addition, those skilled in the art should understand that the shape of the wave plate 100 described above is merely a preferred example, and the wave plate 100 can further be in any shape such as a rectangle, a triangle, or an oval, or an annular shape having a central hole of any shape, as long as the wave plate 100 is arranged on the optical path to allow 25%-75% of the incident laser beam to pass through directly, that is, if a polarization state of 25%-75% of laser of the incident laser beam is not changed and a polarization state of 75%-25% of the laser of the incident laser beam is changed, the laser speckle phenomenon of the incident laser beam can be eliminated.

Further, this embodiment provides a laser source, comprising a laser device for emitting laser and the speckle elimination apparatus described above, in which a laser speckle phenomenon of linearly polarized light emitted by the laser device can be eliminated after the linearly polarized light passes through the wave plate 100.

Further, this embodiment provides a laser projection system comprising the laser source described above.

Obviously, the embodiments of the present utility model described above are merely for clear illustration of examples in the present utility model, instead of for limitation to the implementations of the present utility model. Based on the above description, those skilled in the art could make variations or modifications in other different forms. All the implementations cannot be exhaustively listed herein, and any obvious variations or modifications derived from the technical solutions of the present utility model still fall within the protection scope of the present utility model.

1. A speckle elimination apparatus, comprising a wave plate on a laser optical path, the wave plate being arranged to allow 25%-75% of an incident laser beam to pass through directly.

2. The speckle elimination apparatus according to claim 1, wherein the wave plate is arranged to allow 50% of the incident laser beam to pass through directly.

3. The speckle elimination apparatus according to claim 1, wherein the wave plate is a half-wave plate.

4. The speckle elimination apparatus according to claim 1, wherein the speckle elimination apparatus further comprises a diaphragm on an emergent optical path of the wave plate.

5. The speckle elimination apparatus according to claim 4, wherein the wave plate is an annular wave plate having a central opening.

6. The speckle elimination apparatus according to claim 4, wherein the wave plate is an annular wave plate having a central opening of a centrosymmetric shape, the annular wave plate being arranged concentrically with a light through hole of the diaphragm.

7. The speckle elimination apparatus according to claim 4, wherein the wave plate is an annular wave plate having a central circular opening, the annular wave plate being arranged concentrically with a light through hole of the diaphragm.

8. The speckle elimination apparatus according to claim 4, wherein the wave plate is arranged adjacent to the diaphragm on an optical path direction.

9. A laser source, comprising a laser device for emitting laser, and further comprising the speckle elimination apparatus according to claim 1.

10. A laser projection system, comprising the laser source according to claim 9.

11. A laser source, comprising a laser device for emitting laser, and further comprising the speckle elimination apparatus according to claim 2.

12. A laser source, comprising a laser device for emitting laser, and further comprising the speckle elimination apparatus according to claim 3.

13. A laser source, comprising a laser device for emitting laser, and further comprising the speckle elimination apparatus according to claim 4.

14. A laser source, comprising a laser device for emitting laser, and further comprising the speckle elimination apparatus according to claim 5.

15. A laser source, comprising a laser device for emitting laser, and further comprising the speckle elimination apparatus according to claim 6.

16. A laser source, comprising a laser device for emitting laser, and further comprising the speckle elimination apparatus according to claim 7.

17. A laser source, comprising a laser device for emitting laser, and further comprising the speckle elimination apparatus according to claim 8.
